(19) United States
(12) Patent Application Publication
(10) Pub. No.: US 2016/0344052 A1
(43) Pub. Date: Nov. 24, 2016

(54) PROX REACTION APPARATUS FOR FUEL CELL

(71) Applicant: H&Power, Inc., Daejeon (KR)

(72) Inventors: Woo Jin Kang, Daejeon (KR); In Yong Kang, Daejeon (KR); Byoung Gwan Gwak, Daejeon (KR); Young Gil Choi, Daejeon (KR)

(21) Appl. No.: 14/931,318

(22) Filed: Nov. 3, 2015

(30) Foreign Application Priority Data
May 22, 2015 (KR) 10-2015-0071939

(51) Int. Cl. H01M 8/0612; H01M 8/1018; B01J 19/24

(52) U.S. Cl. CPC H01M 8/0618; B01J 19/2415; H01M 8/1018; B01J 2219/24; B01J 2219/00092; B01J 2219/00132; H01M 2008/1095; H01M 2300/0082

(57) ABSTRACT

Provided is a PROX (preferential oxidation) reaction apparatus for a fuel cell, which includes a mixing chamber to which a reforming gas and a PROX air are introduced, a reforming gas supply tube disposed in the mixing chamber to supply a reforming gas, a heat exchange chamber connected to an upper portion of the mixing chamber, a disk disposed between the mixing chamber and the heat exchange chamber, a cooling water circulation module connected to the heat exchange chamber, and a PROX catalyst chamber disposed above the heat exchange chamber, wherein the reforming gas supplied through a lower portion of the mixing chamber performs multi-stage mixing while passing through the mixing chamber and the disk.

### CROSS-REFERENCE TO RELATED APPLICATION

This application claims priority of Korean Patent Application No. 10-2015-0071939, filed on May 22, 2015, in the KIPO (Korean Intellectual Property Office), the disclosure of which is incorporated herein entirely by reference.

### BACKGROUND OF THE INVENTION

1. Field of the Invention

The present disclosure relates to a design of a PROX (preferential oxidation) reaction apparatus for a fuel cell, and in particular, to a PROX reaction apparatus for a fuel cell, which lowers a concentration of carbon monoxide in a reforming gas supplied in a high-temperature by means of a PROX catalyst reaction under a low-temperature circumstance.

2. Description of the Related Art

Generally, from hydrogen (H₂) gas extracted from a reformer, carbon monoxide which poisons a catalyst present in a fuel cell stack and thus shortens a life cycle of a fuel cell must be removed. For this reason, a PROX (preferential oxidation) catalyst must be used when a fuel cell stack and a reformer are used.

In general case, a reformer is mostly applied to a fuel cell power generation system which uses a fuel cell stack as a power source. In addition, since environment-friendly fuel cell power generation systems are used in a small power generation field instead of diesel power generators causing environmental pollution due to environment-friendly techniques applied over the entire industries, a reformer is used more broadly.

For this reason, a reformer for extracting hydrogen (H₂) gas from a reforming fuel (for example, a hydrocarbon-based fuel such as LPG, LNG and CNG) is provided together with a PROX catalyst, so that carbon monoxide (CO) contained in the hydrogen (H₂) gas extracted by the reformer is removed. In this way, the PROX catalyst represents a catalyst for removing carbon monoxide (CO) in a gas in order to prevent poisoning caused by the carbon monoxide (CO).

Korean Patent Registration No. 10-1050263 (Jul. 12, 2011) may be referred to as a literature disclosing a PROX reaction apparatus. This literature discloses that a reaction tube filled with a PROX catalyst is installed vertically, and a condensed water is easily discharged so that the catalyst is not wet, thereby preventing any hindrance to CO removing reactions and improving CO removing performance of a PROX reactor. However, this literature does not directly disclose a method capable of lowering a concentration of carbon monoxide by lowering a reaction temperature of a reforming gas supplied in a high-temperature state.

### SUMMARY OF THE INVENTION

An embodiment of the present disclosure is directed to providing a PROX reaction apparatus for a fuel cell, which may lower a concentration of carbon monoxide by supplying a small amount of PROX air to a reforming gas supplied in a high-temperature state so that they are mixed at several stages, and also allowing the reforming gas to react in a low-temperature state when passing through a PROX catalyst.

In one general aspect of the present disclosure, there is provided a PROX (preferential oxidation) reaction apparatus for a fuel cell, which includes: a mixing chamber 10 to which a reforming gas and a PROX air are introduced; a reforming gas supply tube 15 disposed in the mixing chamber 10 to supply a reforming gas; a heat exchange chamber 20 connected to an upper portion of the mixing chamber 10; a disk 30 disposed between the mixing chamber 10 and the heat exchange chamber 20; a cooling water circulation module connected to the heat exchange chamber 20; and a PROX catalyst chamber 40 disposed above the heat exchange chamber 20, wherein the reforming gas supplied through a lower portion of the mixing chamber 10 performs multi-stage mixing while passing through the mixing chamber 10 and the disk 30.

The cooling water circulation module may include an insert 22 disposed at an internal center of the heat exchange chamber 20; a spiral cooling tube 24 configured to surround the insert 22; a cooling circulation duct 28 connected to both ends of the spiral cooling tube 24; and a cooling water tank 26 disposed on the cooling circulation duct 28.

The disk 30 may include a ring plate 32 with a predetermined thickness and a mixture gas communication hole 34 formed at a center of the ring plate 32, and the disk 30 may induce secondary mixing of the reforming gas and the PROX air in a state of being disposed between the mixing chamber 10 and the heat exchange chamber 20.

The reforming gas supply tube 15 may be a member having a hollow cylindrical shape with an open lower end and a closed upper end and have reforming gas spray holes 16 formed at an upper portion of a side thereof in a radial direction.

The insert 22 may be a conductor in a sealed shape with a hollow inside.

The PROX reaction apparatus for a fuel cell according to the present disclosure supplies a small amount of PROX air to a reforming gas supplied in a high-temperature state so that they are mixed at several stages, and also allows the reforming gas to react in a low-temperature state when passing through a PROX catalyst, thereby lowering a concentration of carbon monoxide.

The present disclosure allows multi-stage mixing by using a mixing chamber where the supplied reforming gas is primarily mixed with a PROX air and a disk coupled to a top of the mixing chamber to allow secondary mixing.

In addition, the reforming gas mixed in multi stages is cooled at a heat exchange chamber by means of an insert with a hollow sealed shape and by means of circulation of a cooling water and then reacts with a PROX catalyst while maintaining its low-temperature state, thereby effectively lowering a concentration of carbon monoxide.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a perspective view showing a PROX reaction apparatus for a fuel cell according to an embodiment of the present disclosure,

FIG. 2 is an exploded perspective view showing the PROX reaction apparatus for a fuel cell, depicted in FIG. 1,

FIG. 3 is a cross-sectional view showing the PROX reaction apparatus for a fuel cell, depicted in FIG. 1, and

FIG. 4 is a diagram for illustrating operations of the PROX reaction apparatus for a fuel cell.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

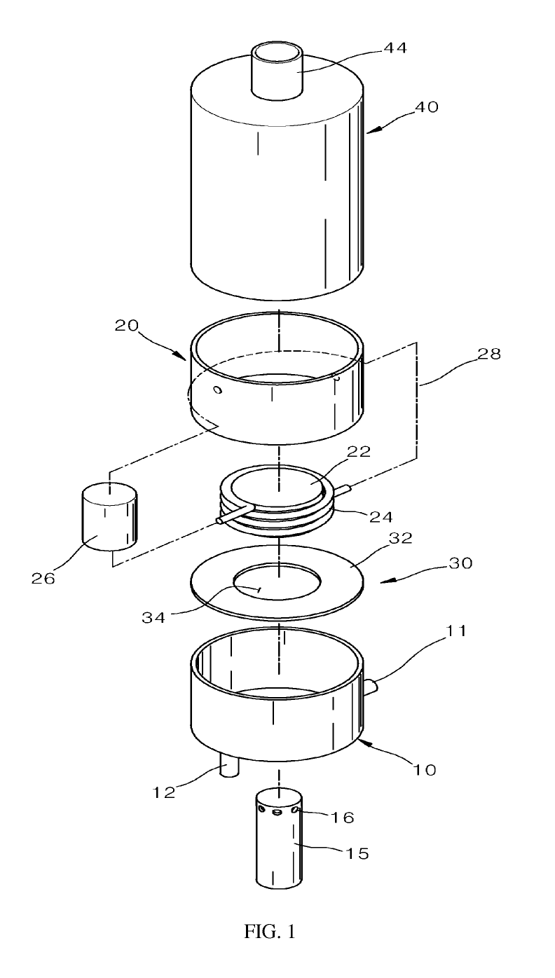

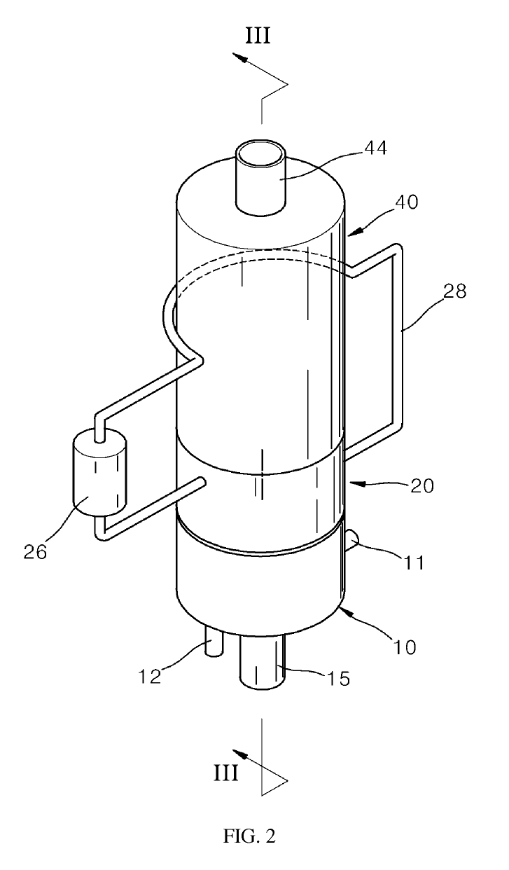

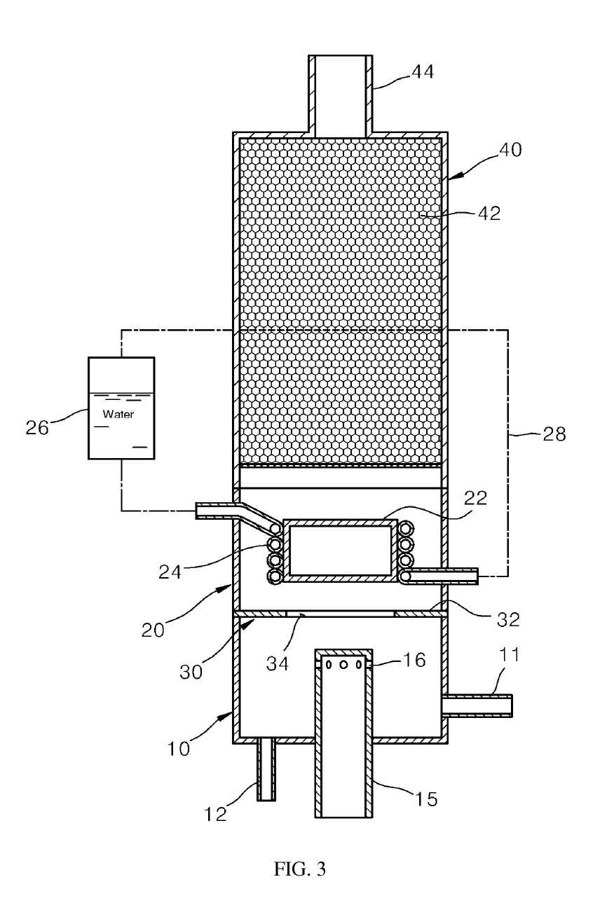

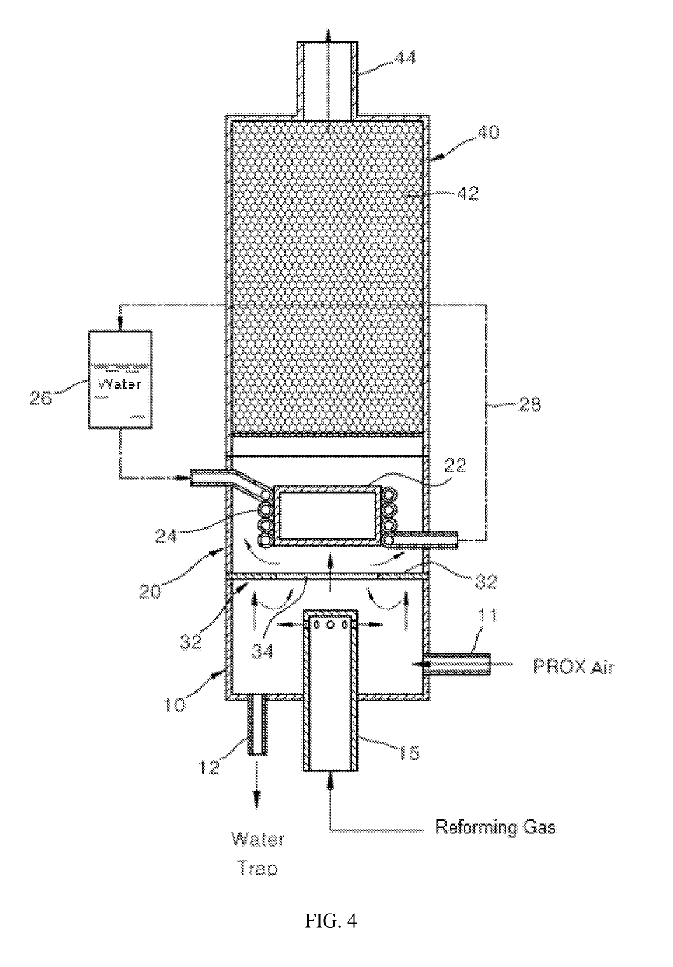

FIG. 1 is a perspective view showing a PROX reaction apparatus for a fuel cell according to an embodiment of the present disclosure, FIG. 2 is an exploded perspective view showing the PROX reaction apparatus for a fuel cell, depicted in FIG. 1, FIG. 3 is a cross-sectional view showing the PROX reaction apparatus for a fuel cell, depicted in FIG. 1, and FIG. 4 is a diagram for illustrating operations of the PROX reaction apparatus for a fuel cell.

As shown in FIGS. 1 to 3, the PROX reaction apparatus for a fuel cell according to the present disclosure includes a mixing chamber 10 to which a reforming gas and a PROX air are introduced, a reforming gas supply tube 15 disposed in the mixing chamber 10, a heat exchange chamber 20 connected to an upper portion of the mixing chamber 10, a disk 30 disposed between the mixing chamber 10 and the heat exchange chamber 20, a cooling water circulation module connected to the heat exchange chamber 20, a PROX catalyst chamber 40 disposed above the heat exchange chamber 20, and a reforming gas discharge tube 44 coupled to the upper end of the PROX catalyst chamber 40.

The mixing chamber 10 is a hollow cylindrical chamber which configures a lowermost portion of the PROX reaction apparatus. A PROX air supply tube 11 is coupled to a side of the mixing chamber 10, and a water trap 12 is coupled to a lower end of the mixing chamber 10.

The reforming gas supply tube 15 is a hollow cylindrical member having an open lower end and a closed upper end, and an upper portion of the reforming gas supply tube 15 is put into the lower end of the mixing chamber 10. In other words, reforming gas spray holes 16 formed at an upper end of a side of the reforming gas supply tube 15 are disposed inside the mixing chamber 10. The reforming gas spray holes 16 are formed at regular intervals along the outer circumference of the reforming gas supply tube 15 to have a radial arrangement. In addition, the reforming gas spray holes 16 may also be disposed at multi stages on the reforming gas supply tube 15.

The disk 30 has a plate shape with a predetermined thickness so as to have a hole vertically formed through the disk 30. In detail, the disk 30 includes a ring plate 32 and a mixture gas communication hole 34 formed at the center of the ring plate 32. In a state where the disk 30 is disposed between the mixing chamber 10 and the heat exchange chamber 20, the disk 30 induces secondary mixing while the mixture gas of the reforming gas and the PROX air mixed at the mixing chamber 10 moves upwards.

The heat exchange chamber 20 is a hollow cylindrical chamber coupled to the upper end of the disk 30 and has opened upper and lower ends.

The cooling water circulation module allows a cooling water to flow through the heat exchange chamber 20, and includes an insert 22 disposed at an inner center of the heat exchange chamber 20, a spiral cooling tube 24 configured to surround the insert 22, a cooling circulation duct 28 connected to both ends of the spiral cooling tube 24, and a cooling water tank 26 disposed on the cooling circulation duct 28.

The insert 22 may be a hollow conductor with a vacant inside and is prepared to have a sealed shape. In an embodiment, the insert 22 may have a hollow cylindrical can shape and be made of general SUS material, without being limited thereto.

The spiral cooling tube 24 is disposed with a downward slope along a side surface of the insert 22 to have a spiral shape, which ensures easy flow of the cooling water. In an embodiment, the spiral cooling tube 24 may be a bellows tube. The cooling water flowing through the spiral cooling tube 24 is heated by means of heat exchange with the mixture gas of the reforming gas and the PROX air, moves along the cooling circulation duct 28 to be cooled at the cooling water tank 26 to its initial temperature, and is then supplied to the spiral cooling tube 24 again.

Meanwhile, the insert 22 may be disposed on the center of the heat exchange chamber 20 so that the mixture gas of the reforming gas and the PROX air flows along the surface of the insert 22. Here, the surface of the insert 22 is heated due to the high-temperature mixture gas.

In other words, in a state where the mixture gas flows along the outer surface of the insert 22, the spiral cooling tube 24 closely adhered to the outer surface of the insert 22 exchanges heat with the high-temperature mixture gas and the insert 22, thereby cooling mixture gas. By doing so, the heat exchange efficiency of the heat exchange chamber 20 is enhanced.

Meanwhile, in order to help the mixture gas of the reforming gas and the PROX air mixed at the mixing chamber 10 to easily flow around the insert 22 in the heat exchange chamber 20, the mixture gas communication hole 34 of the disk 30 may have a diameter corresponding to the diameter of the insert 22.

Hereinafter, operations of the PROX reaction apparatus for a fuel cell according to the present disclosure will be described with reference to FIG. 4.

A reforming gas flows into the lower portion of the mixing chamber 10 through the reforming gas supply tube 15 and is then radially sprayed into the mixing chamber 10 through the reforming gas spray hole 16. The PROX air supplied to a side of the mixing chamber 10 through the PROX air supply tube 11 is primarily mixed with the reforming gas. Here, the supplied reforming gas may maintain a temperature of 250° C. or below, and the PROX air may give an effect just with a very small amount, for example about 2.3 LPM.

The mixed gas of the reforming gas and the PROX air collides with the lower end of the ring plate 32 of the disk 30 to form an eddy while moving upwards, and the eddy may collide with the mixture gas which is to directly flow through the mixture gas communication hole 34, thereby allowing secondary mixing.

The mixture gas of the reforming gas and the PROX air, which has been secondarily mixed, flows into the heat exchange chamber 20 and is cooled by means of the cooling water circulation module and the insert 22. Water generated from the mixture gas while exchanging heat at the heat exchange chamber 20 is discharged to the water trap 12. Since water gives a bad influence on the PROX catalyst 42, the water generated after heat exchange is removed through the water trap 12 installed at the lower end of the mixing chamber 10. Here, the amount of cooling water supplied to the heat exchange chamber 20 is 60 ccm, and by means of the cooling water, the lower inlet of the PROX catalyst chamber 40 may maintain a temperature of 80° C.

The cooled mixture gas moves upwards and flows into the PROX catalyst chamber 40, and also reacts with the PROX catalyst 42 in the PROX catalyst chamber 40. In the PROX catalyst chamber 40, a reaction gas selectively causes an oxidation reaction due to the PROX catalyst 42 so that CO is oxidized into CO₂, thereby removing CO of the reforming gas. The reforming gas free from CO is discharged through the reforming gas discharge tube 44 and supplied to a fuel cell or the like.

The reforming gas generated in the present disclosure may be applied to polymer electrolyte membrane fuel cells (PEMFC). The PEMFC is operated at a low temperature of 60° C. or below and at a CO concentration of 10 ppm. Here, even though CO discharged through an existing high-temperature PROX process has a concentration of 0.2%, the low-temperature PROX mechanism of the present disclosure may lower the CO concentration to 10 ppm or below.

The PROX reaction apparatus for a fuel cell according to the present disclosure as described above allows a reforming gas supplied in a high-temperature state to be mixed in multi stages by supplying a small amount of PROX air thereto, and when the reforming gas passes through the PROX catalyst, the PROX reaction apparatus allows the reforming gas to react in a low-temperature state, thereby reducing a concentration of carbon monoxide.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A PROX (preferential oxidation) reaction apparatus for a fuel cell comprising:
a mixing chamber to which a reforming gas and a PROX air are introduced;
a reforming gas supply tube disposed in the mixing chamber to supply a reforming gas;
a heat exchange chamber connected to an upper portion of the mixing chamber;
a disk disposed between the mixing chamber and the heat exchange chamber;
a cooling water circulation module connected to the heat exchange chamber; and
a PROX catalyst chamber disposed above the heat exchange chamber,
wherein the reforming gas supplied through a lower portion of the mixing chamber performs multi-stage mixing while passing through the mixing chamber and the disk.

2. The PROX reaction apparatus for a fuel cell of claim 1, wherein the cooling water circulation module comprises:
an insert disposed at an internal center of the heat exchange chamber;
a spiral cooling tube configured to surround the insert;
a cooling circulation duct connected to both ends of the spiral cooling tube; and
a cooling water tank disposed on the cooling circulation duct.

3. The PROX reaction apparatus for a fuel cell of claim 2,
wherein the disk includes a ring plate with a predetermined thickness and a mixture gas communication hole formed at a center of the ring plate, and
wherein the disk induces secondary mixing of the reforming gas and the PROX air in a state of being disposed between the mixing chamber and the heat exchange chamber.

4. The PROX reaction apparatus for a fuel cell of claim 1, wherein the reforming gas supply tube is a member having a hollow cylindrical shape with an open lower end and a closed upper end and has reforming gas spray holes formed at an upper portion of a side thereof in a radial direction.

5. The PROX reaction apparatus for a fuel cell of claim 2, wherein the insert is a conductor in a sealed shape with a hollow inside.

6. A PROX (preferential oxidation) reaction apparatus for a fuel cell comprising:
a mixing chamber to which a reforming gas and a PROX air are introduced;
a reforming gas supply tube disposed in the mixing chamber to supply a reforming gas;
a heat exchange chamber connected to an upper portion of the mixing chamber;
a disk disposed between the mixing chamber and the heat exchange chamber, the disk includes a ring plate with a predetermined thickness and a mixture gas communication hole formed at a center of the ring plate;
a cooling water circulation module connected to the heat exchange chamber; and
a PROX catalyst chamber disposed above the heat exchange chamber.

7. The PROX reaction apparatus for a fuel cell of claim 6, wherein the reforming gas supplied through a lower portion of the mixing chamber performs multi-stage mixing while passing through the mixing chamber and the disk.

8. The PROX reaction apparatus for a fuel cell of claim 6, wherein the cooling water circulation module comprises:
an insert disposed at an internal center of the heat exchange chamber;
a spiral cooling tube configured to surround the insert;
a cooling circulation duct connected to both ends of the spiral cooling tube; and
a cooling water tank disposed on the cooling circulation duct.

9. The PROX reaction apparatus for a fuel cell of claim 8, wherein the disk induces secondary mixing of the reforming gas and the PROX air in a state of being disposed between the mixing chamber and the heat exchange chamber.

10. The PROX reaction apparatus for a fuel cell of claim 6, wherein the reforming gas supply tube is a member having a hollow cylindrical shape with an open lower end and a closed upper end and has reforming gas spray holes formed at an upper portion of a side thereof in a radial direction.

11. The PROX reaction apparatus for a fuel cell of claim 8, wherein the insert is a conductor in a sealed shape with a hollow inside.
